(19) United States
(12) Patent Application Publication
(10) Pub. No.: US 2007/0065725 A1
(43) Pub. Date: Mar. 22, 2007

(54) Nonaqueous electrolyte battery

(76) Inventors: Takao Inoue, Hyogo (JP); Kumiko Kanai, Osaka (JP); Kazunori Donoue, Hyogo (JP); Masahide Miyake, Gunma (JP); Masahisa Fujimoto, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/576,260

(22) PCT Filed: Sep. 15, 2004
(86) PCT No.: PCT/JP04/13425

§ 371 Date: Apr. 14, 2006

(30) Foreign Application Priority Data
Oct. 17, 2003 (JP) 2003-357525

(51) Int. Cl. H01M 4/62

(52) U.S. Cl. 429/232

(57) ABSTRACT

A nonaqueous electrolyte battery wherein the capacity per volume of positive electrode active material layer can be larger than in the use of carbon black only as a conductive material. This nonaqueous electrolyte battery comprises positive electrode (1) having a positive electrode active material layer, negative electrode (2) having a negative electrode active material layer, nonaqueous electrolyte (5) and a conductive material incorporated in the positive electrode active material layer, the conductive material containing carbon black of 1 to less than 800 m²/g specific surface area and at least one material selected from the group consisting of nitrides, carbides and borides.

### TECHNICAL FIELD

The present invention relates to a nonaqueous electrolyte battery, and more particularly, it relates to a nonaqueous electrolyte battery whose positive electrode active material layer contains a conductive material.

### BACKGROUND TECHNIQUE

In general, a lithium secondary battery is known as a high-capacity nonaqueous electrolyte battery. Such a lithium secondary battery is disclosed in Japanese Patent Laying-Open No. 10-83818, for example. In this conventional lithium secondary battery, the capacity of the lithium secondary battery has been increased by increasing the filling density of a positive electrode active material layer (mass per volume of the positive electrode active material layer (excluding the mass of a collector)). More specifically, the capacity per volume of the positive electrode active material layer has been increased by employing a layered rock salt material having a high true density as a positive electrode active material constituting the positive electrode active material layer. In general, further, only carbon black having a specific resistance of 40×10⁻⁶ Ωcm to 70×10⁻⁶ Ωcm has been employed as a conductive material contained in the positive electrode active material layer.

In the aforementioned lithium secondary battery as the conventional nonaqueous electrolyte battery, however, there has been such inconvenience that it is difficult to further increase the filling density of the positive electrode active material layer since the true density (2.2 g/ml) of carbon black as the conductive material contained in the positive electrode active material layer is low. Consequently, there has been such a problem that it is difficult to further increase the capacity of the lithium secondary battery (nonaqueous electrolyte battery). Further, there has been such inconvenience that, in a case of setting the dissolution/deposition potential of lithium metal as the reference potential (0 V vs. Li/Li⁺), a nonaqueous electrolyte catalyzed by carbon black is decomposed or anions (negative ions) of the electrolyte are doped into carbon black when 4 V is exceeded with respect to the reference potential. In other words, there has been such a problem that the capacity of the lithium secondary battery (nonaqueous electrolyte battery) lowers due to chemical reaction caused on the interfaces between carbon black and the nonaqueous electrolyte as well as the positive electrode active material under a high voltage (at least 4 V).

### DISCLOSURE OF THE INVENTION

The present invention has been proposed in order to solve the aforementioned problems, and an object of the present invention is to provide a nonaqueous electrolyte battery capable of more increasing the capacity per volume of a positive electrode active material layer than a case of employing only carbon black as a conducting material.

In order to attain the aforementioned object, a nonaqueous electrolyte battery according to a first aspect of the present invention comprises a positive electrode including a positive electrode active material layer, a negative electrode including a negative electrode active material layer, a nonaqueous electrolyte and a conductive material, contained in the positive electrode active material layer, containing carbon black having a specific surface area of at least 1 m²/g and less than 800 m²/g and at least one material selected from a group consisting of nitrides, carbides and borides.

In this nonaqueous electrolyte battery according to the first aspect, the filling density of the positive electrode active material layer (mass per volume of the positive electrode active material layer (excluding the mass of a collector)) can be more increased than a case of employing a conductive material containing only carbon black, by employing the conductive material containing carbon black and at least one material selected from the group consisting of nitrides, carbides and borides as hereinabove described. This is because at least one material selected from the group consisting of nitrides, carbides and borides has a higher true density than carbon black. Thus, it is possible to increase the capacity per volume of the positive electrode active material layer. Further, it is possible to more improve charge/discharge cycle characteristics (capacity retention ratio) than a case of employing a conductive material containing only one material selected from the group consisting of nitrides, carbides and borides. In addition, at least one material selected from the group consisting of nitrides, carbides and borides is a material hardly causing chemical reaction with the nonaqueous electrolyte and a positive electrode active material constituting the positive electrode active material layer under a high voltage (at least 4 V) as compared with carbon black, whereby reduction of the capacity resulting from chemical reaction of at least one material selected from the group consisting of nitrides, carbides and borides can be suppressed. Further, the contact areas on the interfaces between carbon black and the nonaqueous electrolyte as well as the positive electrode active material constituting the positive electrode active material layer can be reduced by setting the specific surface area of carbon black to at least 1 m²/g and less than 800 m²/g, whereby chemical reaction caused on the interfaces between carbon black and the nonaqueous electrolyte as well as the positive electrode active material can be so suppressed that the capacity can be inhibited from reduction as a result. Thus, according to the first aspect, it is possible to increase the capacity of the nonaqueous electrolyte battery and to improve the charge/discharge cycle characteristics while suppressing reduction of the capacity resulting from chemical reaction of the conductive material by employing the conductive material containing carbon black and at least one material selected from the group consisting of nitrides, carbides and borides and setting the specific surface area of carbon black to at least 1 m²/g and less than 800 m²/g.

In the aforementioned nonaqueous electrolyte battery according to the first aspect, the conductive material preferably contains the carbon black and the nitride. The true density of the nitride is higher than the true density of carbon black, whereby the capacity per volume of the positive electrode active material layer can be easily increased. Further, the nitride is a material hardly causing chemical reaction with the nonaqueous electrolyte and the positive electrode active material constituting the positive electrode active material layer under a high voltage (at least 4 V) as compared with carbon black, whereby reduction of the capacity resulting from chemical reaction of the nitride can be easily suppressed.

In the aforementioned nonaqueous electrolyte battery according to the first aspect, the nitride preferably includes a metal nitride. Since the true density (3 g/ml to 17 g/ml) of the metal nitride is higher than the true density (2.2 g/ml) of carbon black, the filling density of the positive electrode active material layer can be easily increased when constituting the conductive material to contain the metal nitride. Further, excellent conductivity can be easily ensured when employing a metal nitride having a specific resistance approximate to the specific resistance (40×10⁻⁶ Ωcm to 70×10⁻⁶ Ωcm) of carbon black.

In this case, the metal nitride preferably includes zirconium nitride (ZrN or Zr₃N₂). Since zirconium nitride has a true density of 7 g/ml and a specific resistance of 13.6×10⁻⁶ Ωcm, it is possible to easily increase the filling density of the positive electrode active material layer while ensuring excellent conductivity. The chemical formula of zirconium nitride is univocally indeterminable, and assumed to be either ZrN or Zr₃N₂.

In the aforementioned nonaqueous electrolyte battery according to the first aspect, at least one material selected from the group consisting of nitrides, carbides and borides preferably has particles of at least 0.2 μm and not more than 5 μm in average particle diameter easily dispersed into the positive electrode active material layer. According to this structure, dispersibility of at least one material selected from the group consisting of nitrides, carbides and borides in the positive electrode active material layer so improves that more excellent conductivity can be ensured.

A nonaqueous electrolyte battery according to a second aspect of the present invention comprises a positive electrode including a positive electrode active material layer, a negative electrode including a negative electrode active material layer, a nonaqueous electrolyte and a conductive material, contained in the positive electrode active material layer, containing carbon black and at least one material, selected from a group consisting of nitrides, carbides and borides, having particles of at least 0.2 μm and not more than 5 μm in average particle diameter easily dispersed into the positive electrode active material layer.

In this nonaqueous electrolyte battery according to the second aspect, the filling density of the positive electrode active material layer (mass per volume of the positive electrode active material layer (excluding the mass of a collector)) can be more increased than a case of employing a conductive material containing only carbon black, by employing the conductive material containing carbon black and at least one material selected from the group consisting of nitrides, carbides and borides as hereinabove described. This is because at least one material selected from the group consisting of nitrides, carbides and borides has a higher true density than carbon black. Thus, it is possible to increase the capacity per volume of the positive electrode active material layer. Further, it is possible to more improve charge/discharge cycle characteristics (capacity retention ratio) than a case of employing a conductive material containing only one material selected from the group consisting of nitrides, carbides and borides. In addition, at least one material selected from the group consisting of nitrides, carbides and borides is a material hardly causing chemical reaction with the nonaqueous electrolyte and a positive electrode active material constituting the positive electrode active material layer under a high voltage (at least 4 V) as compared with carbon black, whereby reduction of the capacity resulting from chemical reaction of at least one material selected from the group consisting of nitrides, carbides and borides can be suppressed. Further, at least one material selected from the group consisting of nitrides, carbides and borides is so constituted as to have the particles of at least 0.2 μm and not more than 5 μm in average particle diameter easily dispersed into the positive electrode active material layer that dispersibility of at least one material selected from the group consisting of nitrides, carbides and borides in the positive electrode active material layer improves, whereby excellent conductivity can be ensured. Thus, according to the second aspect, it is possible to increase the capacity of the nonaqueous electrolyte battery and to improve the charge/discharge cycle characteristics while suppressing reduction of conductivity of the positive electrode active material layer and reduction of the capacity resulting from chemical reaction of the conductive material by employing the conductive material containing carbon black and at least one material selected from the group consisting of nitrides, carbides and borides and constituting at least one material selected from the group consisting of nitrides, carbides and borides to have the particles of at least 0.2 μm and not more than 5 μm in average particle diameter easily dispersed into the positive electrode active material layer.

In the aforementioned nonaqueous electrolyte battery according to the second aspect, the conductive material preferably contains the carbon black and the nitride. The true density of the nitride is higher than the true density of carbon black, whereby the capacity per volume of the positive electrode active material layer can be easily increased. Further, the nitride is a material hardly causing chemical reaction with the nonaqueous electrolyte and the positive electrode active material constituting the positive electrode active material layer under a high voltage (at least 4 V) as compared with carbon black, whereby reduction of the capacity resulting from chemical reaction of the nitride can be easily suppressed.

In the aforementioned nonaqueous electrolyte battery according to the second aspect, the nitride preferably includes a metal nitride. Since the true density (3 g/ml to 17 g/ml) of the metal nitride is higher than the true density (2.2 g/ml) of carbon black, the filling density of the positive electrode active material layer can be easily increased when constituting the conductive material to contain the metal nitride. Further, excellent conductivity can be easily ensured when employing a metal nitride having a specific resistance approximate to the specific resistance (40×10⁻⁶ Ωcm to 70×10⁻⁶ Ωcm) of carbon black.

In this case, the metal nitride preferably includes zirconium nitride (ZrN or Zr₃N₂). Since zirconium nitride has a true density of 7 g/ml and a specific resistance of 13.6×10⁻⁶ Ωcm, it is possible to easily increase the filling density of the positive electrode active material layer while ensuring excellent conductivity. The chemical formula of zirconium nitride is univocally indeterminable, and assumed to be either ZrN or Zr₃N₂.

In the aforementioned nonaqueous electrolyte battery according to the second aspect, the carbon black preferably has a specific surface area of at least 1 m²/g and less than 800 m²/g. According to this structure, the contact areas on the interfaces between carbon black and the nonaqueous electrolyte as well as the positive electrode active material constituting the positive electrode active material layer can be reduced, whereby chemical reaction caused on the interfaces between carbon black and the nonaqueous electrolyte as well as the positive electrode active material can be suppressed. Thus, the capacity can be further inhibited from reduction.

A nonaqueous electrolyte battery according to a third aspect of the present invention comprises a positive electrode including a positive electrode active material layer, a negative electrode including a negative electrode active material layer, a nonaqueous electrolyte and a conductive material, contained in the positive electrode active material layer, containing carbon black having a specific surface area of at least 1 m²/g and less than 800 m²/g and zirconium nitride (ZrN or Zr₃N₂) having particles of at least 0.2 μm and not more than 5 μm in average particle diameter easily dispersed into the positive electrode active material layer.

In this nonaqueous electrolyte battery according to the third aspect, the filling density of the positive electrode active material layer (mass per volume of the positive electrode active material layer (excluding the mass of a collector)) can be more increased than a case of employing a conductive material containing only carbon black, by employing the conductive material containing carbon black and zirconium nitride as hereinabove described. This is because zirconium nitride has a higher true density than carbon black. Thus, it is possible to increase the capacity per volume of the positive electrode active material layer. Further, it is possible to more improve charge/discharge cycle characteristics (capacity retention ratio) than a case of employing a conductive material containing only zirconium nitride. In addition, zirconium nitride is a material hardly causing chemical reaction with the nonaqueous electrolyte and a positive electrode active material constituting the positive electrode active material layer under a high voltage (at least 4 V) as compared with carbon black, whereby reduction of the capacity resulting from chemical reaction of zirconium nitride can be suppressed. Further, zirconium nitride is so constituted as to have the particles of at least 0.2 μm and not more than 5 μm in average particle diameter easily dispersed into the positive electrode active material layer that dispersibility of zirconium nitride in the positive electrode active material layer improves, whereby excellent conductivity can be ensured. In addition, the contact areas on the interfaces between carbon black and the nonaqueous electrolyte as well as the positive electrode active material constituting the positive electrode active material layer can be reduced by setting the specific surface area of carbon black to at least 1 m²/g and less than 800 m²/g, whereby chemical reaction caused on the interfaces between carbon black and the nonaqueous electrolyte as well as the positive electrode active material can be so suppressed that the capacity can be inhibited from reduction as a result. Thus, according to the third aspect, it is possible to increase the capacity of the nonaqueous electrolyte battery and to improve the charge/discharge cycle characteristics while suppressing reduction of conductivity of the positive electrode active material layer and reduction of the capacity resulting from chemical reaction of the conductive material by employing the conductive material containing carbon black having the specific surface area of at least 1 m²/g and less than 800 m²/g and zirconium nitride having the particles of at least 0.2 μm and not more than 5 μm in average particle diameter easily dispersed into the positive electrode active material layer.

### BRIEF DESCRIPTION OF THE DRAWINGS

FIG. 1 is a graph showing particle size distribution of zirconium nitride constituting a conductive material employed in Example 1.

FIG. 2 is an SEM (Scanning Electron Microscope: scanning electron microscope) photograph of zirconium nitride constituting the conductive material employed in Example 1.

FIG. 3 is a perspective view showing a test cell prepared for checking the characteristics of positive electrodes of lithium secondary batteries (nonaqueous electrolyte batteries) according to Examples 1 to 3, comparative example 1 and comparative example 2.

FIG. 4 is a graph showing results of a charge/discharge test performed as to a test cell corresponding to Example 1.

FIG. 5 is a graph showing results of a charge/discharge test performed as to a test cell corresponding to Example 2.

FIG. 6 is a graph showing results of a charge/discharge test performed as to a test cell corresponding to Example 3.

FIG. 7 is a graph showing results of a charge/discharge test performed as to a test cell corresponding to comparative example 1.

FIG. 8 is a graph showing results of a charge/discharge test performed as to a test cell corresponding to comparative example 2.

### BEST MODES FOR CARRYING OUT THE INVENTION

Examples of the present invention are now specifically described.

### Example 1

[Preparation of Positive Electrode]

According to this Example 1, a conductive material containing carbon black having a specific surface area of 12 m²/g and zirconium nitride having particles of at least 0.2 μm and not more than 5 μm in average particle diameter easily dispersed into a positive electrode active material layer was employed as the conductive material constituting the positive electrode active material layer. Carbon black has a true density of 2.2 g/ml and a specific resistance of 40×10⁻⁶ Ωcm to 70×10⁻⁶ Ωcm, while zirconium nitride has a true density of 7 g/ml and a specific resistance of 13.6×10⁻⁶ Ωcm. Lithium cobaltate (LiCoO₂) and polyvinylidene fluoride (PVdF) were employed as a positive electrode active material and a binder constituting the positive electrode active material layer respectively. Lithium cobaltate has a layered rock salt structure and a true density of 5 g/ml.

Particle size distribution measurement was performed in order to check the specific average particle diameter of zirconium nitride constituting the conductive material employed in Example 1. A laser diffraction particle size distribution measuring apparatus (SALD-2000, by Shimadzu Corporation) was employed for the particle size distribution measurement. The average particle diameter is a median diameter measured with the laser diffraction particle size distribution measuring apparatus.

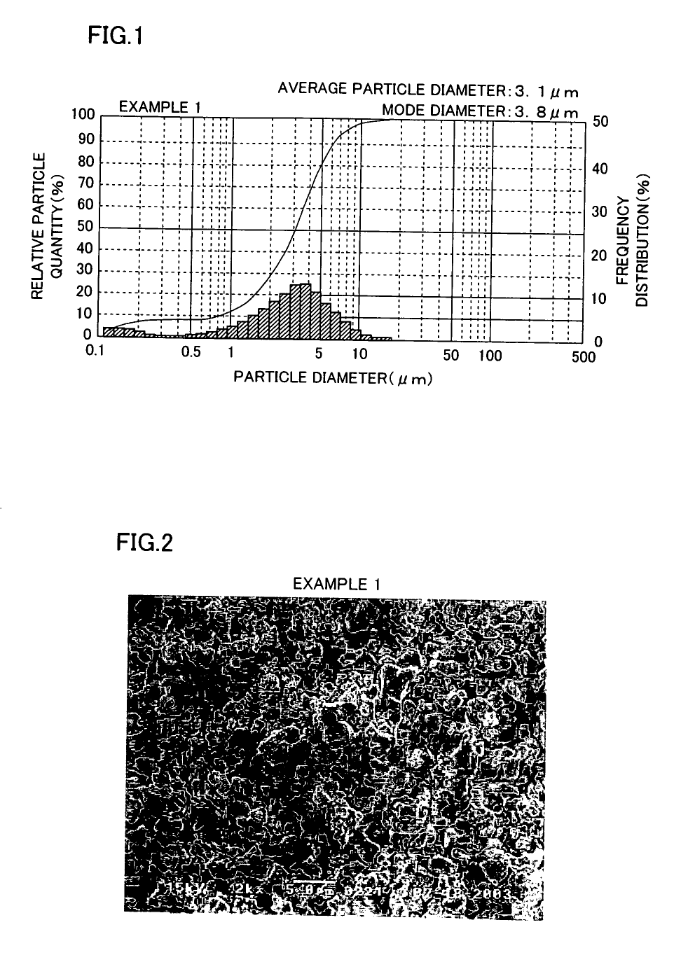

FIG. 1 shows the particle size distribution of zirconium nitride constituting the conductive material employed in Example 1. The particle diameter (μm) is plotted on the abscissa of FIG. 1. Further, the relative particle quantity (%) is plotted on the left ordinate of FIG. 1, and shown by a curvilinear graph. Frequency distribution (%) is plotted on the right ordinate of FIG. 1, and shown by a bar graph. The relative particle quantity is the proportion of particles of not more than a prescribed particle diameter with respect to the overall particle quantity. The frequency distribution is the proportion of particles present in each particle diameter range with respect to the overall particle quantity when the range of the particle diameters is divided at regular intervals. The mode diameter in FIG. 1 is the particle diameter of particles maximumly present in the measured object.

Referring to FIG. 1, the average particle diameter (median diameter) of zirconium nitride constituting the conductive material employed in Example 1 is 3.1 μm, and it has been confirmable that the average particle diameter is at least 0.2 μm and not more than 5 μm. Further, the mode diameter is 3.8 μm, and it has been confirmable that the particles having particle diameters of at least 0.2 μm and not more than 5 μm are maximumly present.

Referring to FIG. 2, it has been proved that particles of zirconium nitride constituting the conductive material employed in Example 1 homogeneously disperse over the whole. From this result, it is conceivable that dispersibility of the particles improves when the average particle diameter of zirconium nitride is at least 0.2 μm and not more than 5 μm.

Then, the aforementioned materials constituting the positive electrode active material layer were mixed with each other so that the mass ratios of lithium cobaltate (positive electrode active material), carbon black (conductive material), zirconium nitride (conductive material) and polyvinylidene fluoride (binder) were 94:1:2:3. Then, N-methyl-2-pyrrolidone was added to this mixture for preparing a positive electrode mixture slurry as the positive electrode active material layer. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to Example 1. According to Example 1, the filling density of the positive electrode active material layer (mass per volume of the positive electrode active material layer) constituting the positive electrode was 4.13 g/ml. The filling density of the positive electrode active material layer in the present invention is that exclusive of the aluminum foil as the collector.

### Example 2

[Preparation of Positive Electrode]

According to this Example 2, a conductive material containing carbon black having a specific surface area of 39 m²/g and zirconium nitride having particles of at least 0.2 μm and not more than 5 μm in average particle diameter easily dispersed into a positive electrode active material layer was employed as the conductive material constituting the positive electrode active material layer. As a result of performing particle size distribution measurement similar to that in the aforementioned Example 1 on zirconium nitride constituting the conductive material, the specific average particle diameter of zirconium nitride was 3.1 μm. As a positive electrode active material layer and a binder constituting the positive electrode active material layer, lithium cobaltate and polyvinylidene fluoride were employed respectively.

Similarly to the aforementioned Example 1, a positive electrode mixture slurry as the positive electrode active material layer was so prepared that the mass ratios of lithium cobaltate (positive electrode active material), carbon black (conductive material), zirconium nitride (conductive material) and polyvinylidene fluoride (binder) were 94:1:2:3. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to Example 2. According to Example 2, the filling density of the positive electrode active material layer constituting the positive electrode was 4.20 g/m.

### Example 3

[Preparation of Positive Electrode]

According to this Example 3, a conductive material containing carbon black having a specific surface area of 70 m²/g and zirconium nitride having particles of at least 0.2 μm and not more than 5 μm in average particle diameter easily dispersed into a positive electrode active material layer was employed as the conductive material constituting the positive electrode active material layer. As a result of performing particle size distribution measurement similar to that in the aforementioned Example 1 on zirconium nitride constituting the conductive material, the specific average particle diameter of zirconium nitride was 3.1 μm. As a positive electrode active material layer and a binder constituting the positive electrode active material layer, lithium cobaltate and polyvinylidene fluoride were employed respectively.

The aforementioned materials constituting the positive electrode active material layer were so mixed with each other that the mass ratios of lithium cobaltate (positive electrode active material), carbon black (conductive material), zirconium nitride (conductive material) and polyvinylidene fluoride (binder) were 91:1:5:3. Similarly to the aforementioned Example 1, N-methyl-2-pyrrolidone was added to this mixture for preparing a positive electrode mixture slurry as the positive electrode active material layer. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to Example 3. According to Example 3, the filling density of the positive electrode active material layer constituting the positive electrode was 4.16 g/m.

### Comparative Example 1

[Preparation of Positive Electrode]

According to this comparative example 1, a conductive material containing carbon black having a specific surface area of 800 m²/g and zirconium nitride having an average particle diameter of 3.1 μm was employed as the conductive material constituting a positive electrode active material layer. As a positive electrode active material layer and a binder constituting the positive electrode active material layer, lithium cobaltate and polyvinylidene fluoride were employed respectively.

Similarly to the aforementioned Example 3, a positive electrode mixture slurry as the positive electrode active material layer was so prepared that the mass ratios of lithium cobaltate (positive electrode active material), carbon black (conductive material), zirconium nitride (conductive material) and polyvinylidene fluoride (binder) were 91:1:5:3. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to comparative example 1. According to comparative example 1, the filling density of the positive electrode active material layer constituting the positive electrode was 4.09 g/m.

### Comparative Example 2

According to this comparative example 2, a conductive material containing only zirconium nitride of 3.1 μm in average particle diameter was employed as the conductive material constituting a positive electrode active material layer. As a positive electrode active material layer and a binder constituting the positive electrode active material layer, lithium cobaltate and polyvinylidene fluoride were employed respectively.

The aforementioned materials constituting the positive electrode active material layer were so mixed with each other that the mass ratios of lithium cobaltate (positive electrode active material), zirconium nitride (conductive material) and polyvinylidene fluoride (binder) were 87:10:3. Similarly to the aforementioned Example 1, N-methyl-2-pyrrolidone was added to this mixture for preparing a positive electrode mixture slurry as the positive electrode active material layer. Finally, the positive electrode mixture slurry as the positive electrode active material layer was applied onto aluminum foil as a collector, and the collector and the positive electrode active material layer were thereafter cut into quadratic forms 2 cm square, thereby preparing a positive electrode of a lithium secondary battery (nonaqueous electrolyte battery) according to comparative example 2. According to comparative example 2, the filling density of the positive electrode active material layer constituting the positive electrode was 4.49 g/m.

### Common to Examples 1 to 3, Comparative Example 1 and Comparative Example 2

[Preparation of Nonaqueous Electrolyte]

A nonaqueous electrolyte of the lithium secondary battery (nonaqueous electrolyte battery) was prepared by dissolving 1 mol/liter of lithium hexafluorophosphate (LiPF₆) as an electrolyte (solute) in a mixed solvent obtained by mixing ethylene carbonate (EC) and diethyl carbonate (DEC) at a volume ratio of 50:50.

[Preparation of Test Cell]

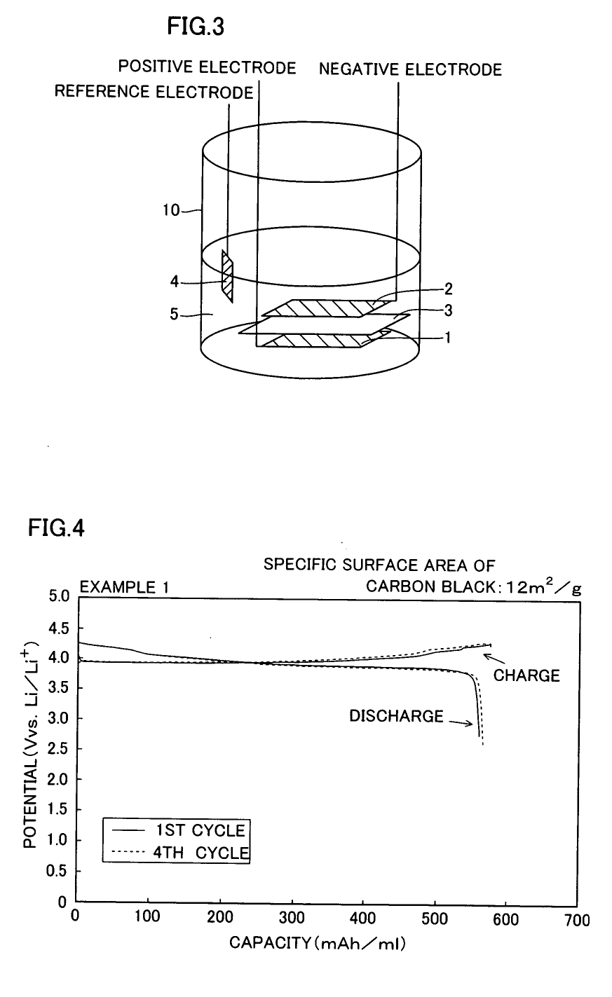

Referring to FIG. 3, a positive electrode 1 and a negative electrode 2 were arranged in a vessel 10 so that the positive electrode 1 and the negative electrode 2 were opposed to each other through a separator 3, while a reference electrode 4 was also arranged in the vessel 10 as a preparation process for a test cell. The test cell was prepared by injecting a nonaqueous electrolyte 5 into the vessel 10. A positive electrode prepared in the aforementioned manner was employed as the positive electrode 1, while lithium (Li) metal was employed as the negative electrode 2 and the reference electrode 3. A nonaqueous electrolyte prepared in the aforementioned manner was employed as the nonaqueous electrolyte 5.

[Charge/Discharge Test]

Charge/discharge tests were performed as to respective test cells corresponding to Examples 1 to 3, comparative example 1 and comparative example 2 prepared in the aforementioned manner. As to conditions of this charging/discharging, charging was performed up to 4.3 V with constant current of 1.5 mA, and discharging was thereafter performed up to 2.75 V with the constant current of 1.5 mA. This charging/discharging was assumed to be one cycle, for measuring first-cycle and fourth-cycle post-discharge capacities.

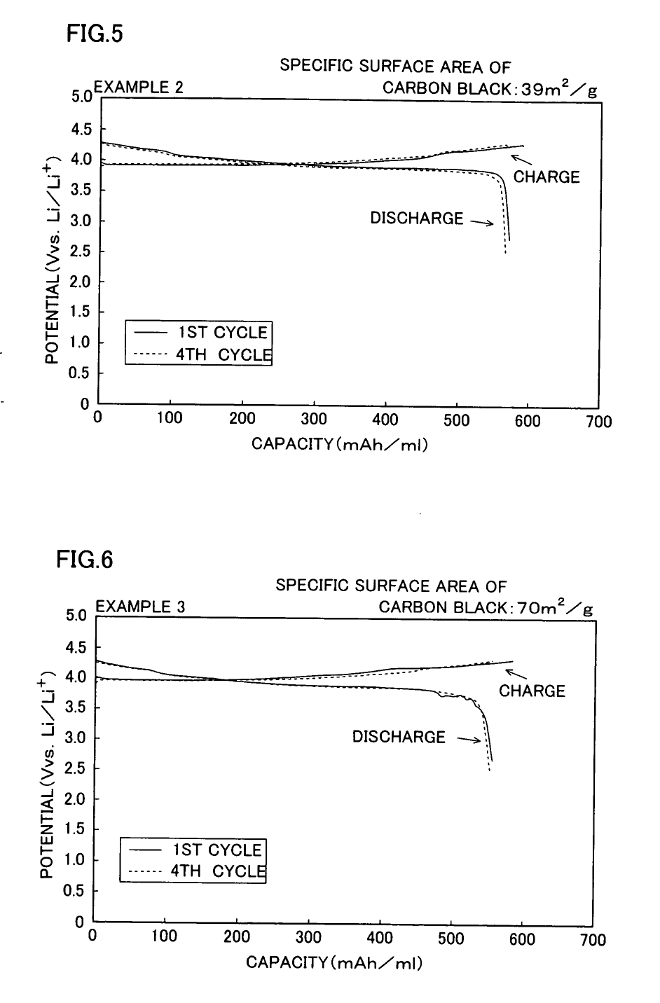

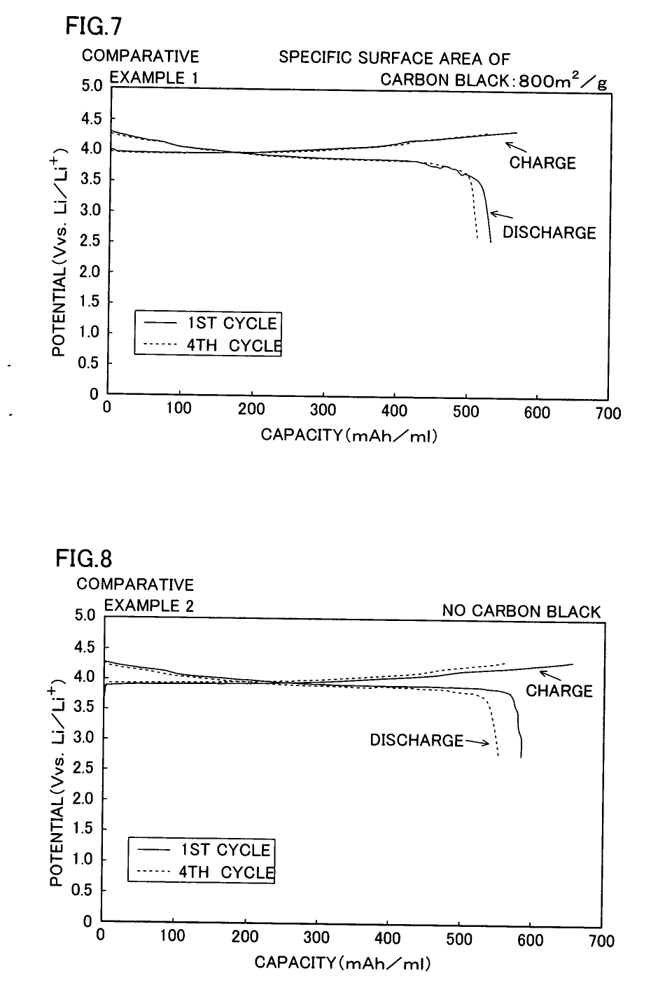

Referring to FIGS. 4 to 7, it has been proved that the first-cycle post-discharge capacities are higher in Examples 1 to 3 in which the specific surfaces areas of carbon black constituting the conductive materials are at least 1 m²/g and less than 800 m²/g than comparative example 1 in which the specific surface area of carbon black is 800 m²/g. More specifically, the first-cycle post-discharge capacity of Example 1 (see FIG. 4) in which the specific surface area of carbon black is 12 m²/g was 560 mAh/ml. The first-cycle post-discharge capacity of Example 2 (see FIG. 5) in which the specific surface area of carbon black is 39 m²/g was 572 mAh/ml. The first-cycle post-discharge capacity of Example 3 (see FIG. 6) in which the specific surface area of carbon black is 70 m²/g was 557 mAh/ml. I other words, it was possible to obtain high capacities (at least 557 mAh/ml) in Examples 1 to 3 after the first-cycle discharging. On the other hand, the first-cycle post-discharge capacity of comparative example 1 (see FIG. 7) in which the specific surface area of carbon black is 800 m²/g was 532 mAh/ml. The capacities (mAh/ml) shown in FIGS. 4 to 7 are capacities per volume of the positive electrode active material layers.

From this result, it is conceivable that reduction of the capacities was suppressed in Examples 1 to 3 by setting the specific areas of carbon black constituting the conductive materials to at least 1 m²/g and less than 800 m²/g. In other words, it is conceivable that the contact areas on the interfaces between carbon black and the nonaqueous electrolytes as well as the positive electrode active materials can be reduced by setting the specific areas of carbon black constituting the conductive materials to at least 1 m²/g and less than 800 m²/g, whereby chemical reaction caused on the interfaces between carbon black and the nonaqueous electrolytes as well as the positive electrode active materials can be suppressed and the capacities can be inhibited from reduction as a result.

Referring to FIGS. 4 to 6 and FIG. 8, it has been proved that capacity retention ratios (ratios of fourth-cycle post-discharge capacities to first-cycle post-discharge capacities) more improve in Examples 1 to 3 employing the conductive materials containing carbon black and zirconium nitride than comparative example 2 employing the conductive material containing only zirconium nitride. More specifically, the first-cycle post-discharge capacities of Example 1 (see FIG. 4), Example 2 (see FIG. 5) and Example 3 (see FIG. 6) employing the conductive materials containing carbon black and zirconium nitride were 560 mAh/ml, 572 mAh/ml and 557 mAh/ml respectively, and the fourth-cycle post-discharge capacities were 566 mAh/ml, 567 mAh/ml and 555 mAh/ml respectively. In other words, the capacity retention ratios of Example 1, Example 2 and Example 3 were 100%, 99.1% and 99.6% respectively. In comparative example 2 (see FIG. 8) employing the conductive material containing only zirconium nitride, on the other hand, the first-cycle and fourth-cycle post-discharge capacities were 585 mAh/ml and 553 mAh/ml respectively. In other words, the capacity retention ratio of comparative example 2 was 94.5%. The capacities (mAh/ml) shown in FIG. 8 are capacities per volume of the positive electrode active material layers.

From this result, it is conceivable that the capacity retention ratios were employed in Examples 1 to 3 due to the employment of the conductive materials containing carbon black and zirconium nitride. In other words, it is conceivably possible to more improve the charge/discharge cycle characteristics (capacity retention ratios) in Examples 1 to 3 than a case of employing a conductive material containing only zirconium nitride, by employing the conductive materials containing carbon black and zirconium nitride.

It has been proved that the charge/discharge cycle characteristics improve while the first-cycle capacities lower in Examples 1 to 3 as compared with comparative example 2. This is conceivably because the filling density of the positive electrode active material layer was more increased in comparative example 2 employing the conductive material containing only zirconium nitride having the true density (7 g/ml) higher than the true density (2.2 g/ml) of carbon black than Examples 1 to 3 employing the conductive materials containing carbon black and zirconium nitride.

According to Examples 1 to 3, as hereinabove described, it is possible to improve the charge/discharge cycle characteristics while suppressing reduction of the capacities resulting from chemical reaction caused on the interfaces between carbon black and the nonaqueous electrolytes as well as the positive electrode active materials by employing the conductive materials containing carbon black and zirconium nitride and setting the specific surface areas of carbon black to at least 1 m²/g and less than 800 m²/g.

According to Examples 1 to 3, as hereinabove described, the filling densities of the positive electrode active material layers can be more increased than the case of employing the conductive material containing only carbon black due to the employment of the conductive materials containing carbon black having the true density of 2.2 g/ml and zirconium nitride having the true density of 7 g/ml, whereby the capacities per volume of the positive electrode active material layers can be increased. Further, zirconium nitride is a material hardly causing chemical reaction with a nonaqueous electrolyte and a positive electrode active material under a high voltage (at least 4 V) as compared with carbon black, whereby reduction of the capacities resulting from chemical reaction of zirconium nitride can be suppressed. In addition, dispersibility of zirconium nitride in the positive electrode active material layers can be improved by setting the average particle diameters of zirconium nitride to at least 0.2 μm and not more than 5 μm, whereby excellent conductivity can be ensured. Further, the specific resistance (13.6×10⁻⁵ Ωcm) of zirconium nitride is approximate to the specific resistance (40×10⁻⁶ Ωcm to 70×10⁻⁶ Ωcm) of carbon black, whereby the conductivity is not reduced due to the employment of the conductive materials containing carbon black and zirconium nitride.

Examples disclosed this time must be considered as illustrative in all points and not restrictive. The scope of the present invention is shown not by the above description of Examples but by the scope of claim for patent, and all modifications within the meaning and range equivalent to the scope of claim for patent are included.

For example, while the examples of applying the present invention to lithium secondary batteries have been described in the above Examples, the present invention is not restricted to this but is also applicable to a nonaqueous electrolyte battery other than the lithium secondary battery.

While zirconium nitride was employed as the material constituting the conductive materials with carbon black in the aforementioned Examples, the present invention is not restricted to this but similar effects can be attained also when employing at least one material selected from a group consisting of nitrides other than zirconium nitride, carbides and borides. As a metal nitride other than zirconium nitride, at least one material selected from a group consisting of NbN, TiN, Ti₃N₄, VN, Cr₂N, Fe₂N, Cu₃N, GaN, Mo₂N, Ru₂N, TaN, Ta₂N, HfN, ThN₂, Mo₂N, Mn₃N₂, Co₃N₂, Ni₃N₂, W₂N and Os₂N can be listed, for example. Among the aforementioned metal nitrides, TiN, Ti₃N₄, TaN and Ta₂N have specific resistances approximate to the specific resistance (40×10⁻⁶ Ωcm to 70×10⁻⁶ Ωcm) of carbon black, whereby it is possible to ensure more excellent conductivity when employing TiN, Ti₃N₄, TaN or Ta₂N. The specific resistances of TiN and Ti₃N₄ are 21.7×10⁻⁶ Ωcm, and the specific resistances of TaN and Ta₂N are 200×10⁻⁶ Ωcm.

While zirconium nitride having the specific resistance (13.6×10⁻⁶ Ωcm) approximate to the specific resistance (40×10⁻⁶ Ωcm to 70×10⁻⁶ Ωcm) of carbon black was employed as the material constituting the conductive materials with carbon black in the aforementioned Examples, the present invention is not restricted to this but a material inferior in conductivity as compared with carbon black may be employed as the conducting material if it is possible to increase the filling density of the positive electrode active material layer.

While zirconium nitride having the average particle diameter of 3.1 μm was employed as the material constituting the conductive materials with carbon black in the aforementioned Examples, the present invention is not restricted to this but similar effects can be attained when the average particle diameter of zirconium nitride is at least 0.2 μm and not more than 5 μm. If the average particle diameter of zirconium nitride exceeds 5 μm, it is conceivably rendered difficult to ensure excellent conductivity since dispersion of the conductive material is conceivably inhomogenized to reduce the dispersibility. If the average particle diameter of zirconium nitride is smaller than 0.2 μm, on the other hand, it is conceivably rendered difficult to ensure sufficient conductivity since the contact area between conductive materials contained in the positive electrode active material layer decreases.

While the components of the positive electrode active material layers were so mixed with each other that the mass ratios of zirconium nitride constituting the conductive materials were 2% (Examples 1 and 2) and 5% (Example 3) in the aforementioned Examples, the present invention is not restricted to this but the mass ratio of zirconium nitride may simply be at least 0.1% and not more than 5%. It is more preferable if the mass ratio of zirconium nitride is at least 0.1% and not more than 3%, and it is further preferable if the same is at least 0.1% and not more than 2%.

While the components of the positive electrode active material layers were so mixed with each other that the mass ratios of carbon black constituting the conductive materials were 1% in the aforementioned Examples, the present invention is not restricted to this but the mass ratio of carbon black may simply be not more than 3%. It is more preferable if the mass ratio of carbon black is not more than 2%, and it is further preferable if the same is not more than 1%.

While lithium cobaltate (LiCoO₂) was employed as the positive electrode active materials in the aforementioned Examples, the present invention is not restricted to this but a material other than lithium cobaltate may be employed as the positive electrode active material if it is possible to occlude and discharge lithium. As materials other than lithium cobaltate employable as positive electrode active materials, oxides having tunnel holes such as Li₂FeO₃, TiO₂ and V₂O₅ which are inorganic compounds and metallic chalcogen compounds having layered structures such as TiS₂ and MoS₂, for example. As the positive electrode active material, it is more preferable to employ a composite oxide having a composition formula expressed as LiₓMO₂ (0≦x≦1) or Li_{y}M₂O₄ (0≦y≦2). M in the composition formula is a transition element. As composite oxides having the aforementioned composition formula, LiMnO₂, LiNiO₂, LiCrO₂ and LiMn₂O₄ can be listed, for example. Further, a partial substitute of the Li site and a partial substitute of the transition metal may also be employed.

While the nonaqueous electrolytes containing the mixed solvents of ethylene carbonate and diethyl carbonate were employed in the aforementioned Examples, the present invention is not restricted to this but a solvent other than the mixed solvent of ethylene carbonate and diethyl carbonate may be employed if the same is usable as the solvent of the nonaqueous electrolyte battery. As solvents other than the mixed solvent of ethylene carbonate and diethyl carbonate, cyclic carbonic acid ester, chain carbonic acid ester, esters, cyclic ethers, chain ethers, nitriles and amides can be listed, for example. As cyclic carbonic acid ester, propylene carbonate and butylene carbonate can be listed, for example. Further, cyclic carbonic acid ester whose hydrogen groups are partially or entirely fluorinated is also usable, and trifluoropropylene carbonate and fluoroethyl carbonate can be listed, for example. As chain carbonic acid ester, dimethyl carbonate, ethyl methyl carbonate, methyl propyl carbonate, ethyl propyl carbonate and methyl isopropyl carbonate can be listed, for example. Chain carbonic acid ester whose hydrogen groups are partially or entirely fluorinated is also usable.

As esters, methyl acetate, ethyl acetate, propyl acetate, methyl propionate, ethyl propionate and γ-butyrolactone can be listed, for example. As cyclic ethers, 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol and crown ether can be listed. As chain ethers, 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, bentyl phenyl ether, methoxytoluene, benzyl ethyl ether, diphenyl ether, dibenzyl ether, 0-dimethoxy benzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether and tetraethylene glycol dimethyl can be listed, for example. As nitriles, acetonitrile can be listed, for example. As amides, dimethylformamide can be listed, for example.

While the nonaqueous electrolytes in which lithium hexafluorophosphate (LiPF₆) as the solute (electrolytic salt) was dissolved were employed in the aforementioned Examples, the present invention is not restricted to this but a nonaqueous electrolyte in which a solute other than lithium hexafluorophosphate is dissolved may be employed. As solutes other than lithium hexafluorophosphate, lithium difluoro(oxalate)borate (substance expressed in the following chemical formula Chem 1), LiAsF₆, LiBF₄, LiCF₃SO₃, LiN(CₗF₂ₗ₊₁SO₂)(CₘF₂ₘ₊₁SO₂) and LiC(CₚF₂ₚ₊₁SO₂)(C_{q}F_{2q+1}SO₂)(CᵣF₂ᵣ₊₁SO₂) can be listed, for example. l, m, p, q and r in the above composition formulas are integers of at least 1. Further, a mixture obtained by combining at least two materials selected from the group consisting of the aforementioned solutes may be employed as the solute. The aforementioned solute is preferably dissolved in the solvent with a concentration of 0.1 M to 1.5 M. Further, the aforementioned solute is more preferably dissolved in the solvent with a concentration of 0.5 M to 1.5 M.

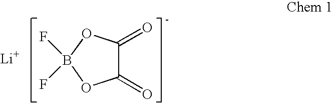

While the lithium metal was employed as the negative electrodes in the aforementioned Examples, the present invention is not restricted to this but a material other than the lithium metal may be employed as a negative electrode active material if it is possible to occlude and discharge lithium. As materials employable as negative electrode active materials, carbon materials such as a lithium alloy and graphite and silicon can be listed, for example. Since silicon has a high capacity, a nonaqueous electrolyte battery of a high energy density can be obtained when employing a negative electrode containing a negative electrode active material constituted of silicon. This is disclosed in International Patent Laying-Open No. WO01/29912, for example. When forming a negative electrode active material layer on a collector, it is preferable to employ a surface-roughened collector. Further, it is preferable to form the negative electrode active material layer to be columnar. In addition, it is preferable to form the negative electrode active material layer so that the components of the collector are dispersed therein. When forming the negative electrode active material layer in this manner, it is possible to improve the charge/discharge characteristics of the nonaqueous electrolyte battery.

1] A nonaqueous electrolyte battery comprising:
a positive electrode (1) including a positive electrode active material layer;
a negative electrode (2) including a negative electrode active material layer;
a nonaqueous electrolyte (5); and
a conductive material, contained in said positive electrode active material layer, containing carbon black having a specific surface area of at least 1 m²/g and less than 800 m²/g and a nitride having particles of at least 0.2 μm and not more than 5 μm in average particle diameter easily dispersed into said positive electrode active material layer.

2] (canceled)

3] The nonaqueous electrolyte battery according to claim 1, wherein said nitride includes a metal nitride.

4] The nonaqueous electrolyte battery according to claim 3, wherein said metal nitride includes zirconium nitride (ZrN or Zr₃N₂).

5] (canceled)

6] A nonaqueous electrolyte battery comprising:
a positive electrode (1) including a positive electrode active material layer;
a negative electrode (2) including a negative electrode active material layer;
a nonaqueous electrolyte (5); and
a conductive material, contained in said positive electrode active material layer, containing carbon black and a nitride having particles of at least 0.2 μm and not more than 5 μm in average particle diameter easily dispersed into said positive electrode active material layer.

7] (canceled)

8] The nonaqueous electrolyte battery according to claim 6, wherein said nitride includes a metal nitride.

9] The nonaqueous electrolyte battery according to claim 8, wherein said metal nitride includes zirconium nitride (ZrN or Zr₃N₂).

10] The nonaqueous electrolyte battery according to claim 6, wherein said carbon black has a specific surface area of at least 1 m²/g and less than 800 m²/g.

11] A nonaqueous electrolyte battery comprising:
a positive electrode (1) including a positive electrode active material layer;
a negative electrode (2) including a negative electrode active material layer;
a nonaqueous electrolyte (5); and
a conductive material, contained in said positive electrode active material layer, containing carbon black having a specific surface area of at least 1 m²/g and less than 800 m²/g and zirconium nitride (ZrN or Zr₃N₂) having particles of at least 0.2 μm and not more than 5 μm in average particle diameter easily dispersed into said positive electrode active material layer.
